(19) United States
(12) Patent Application Publication
(10) Pub. No.: US 2013/0194585 A1
(43) Pub. Date: Aug. 1, 2013

(54) PROPER INSTALLATION DETERMINATION BASED ON ARBITRARY PATTERN IDENTIFICATION

(71) Applicants: David R. Cowles, Granite Bay, CA (US); Rajeev Grover, Rocklin, CA (US)

(72) Inventors: David R. Cowles, Granite Bay, CA (US); Rajeev Grover, Rocklin, CA (US)

(21) Appl. No.: 13/360,284

(22) Filed: Jan. 27, 2012

(51) Int. Cl. G01B 11/14

(52) U.S. Cl. 356/614

(57) ABSTRACT

An optical emitter may be associated with an arbitrary pattern to be reflected by a component. A controller may determine proper installation of the component based on identifying the arbitrary pattern in a received optical signal.

### BACKGROUND

A computing device may be associated with various components to be installed. A component may enable the computing device to operate, and may be optional. The computing device may be impaired if operated improperly, including operating the computing device with or without a component, or with an improperly installed component.

BRIEF DESCRIPTION OF THE DRAWINGS/FIGURES

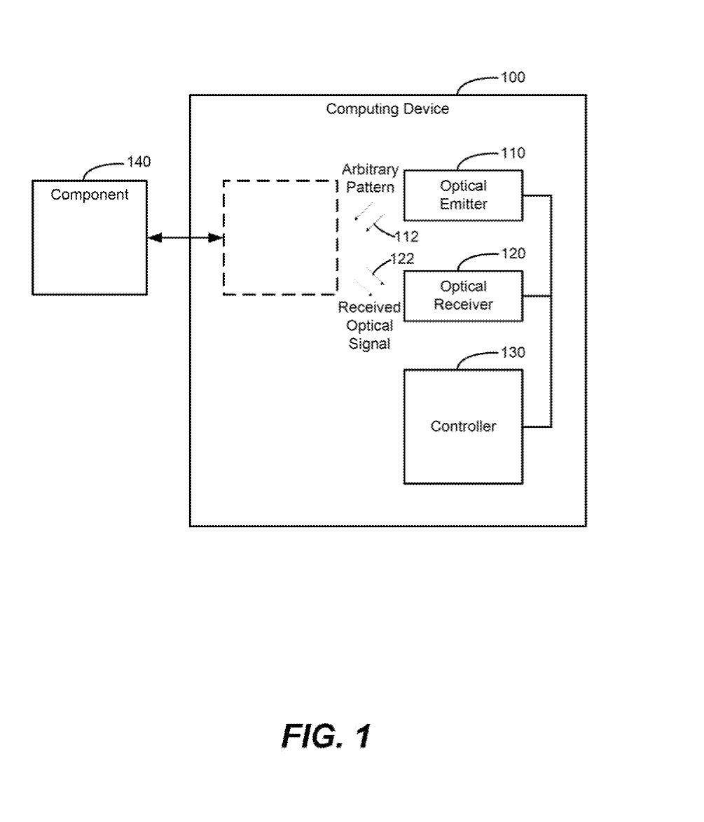

FIG. 1 is a block diagram of a computing device including an arbitrary pattern according to an example.

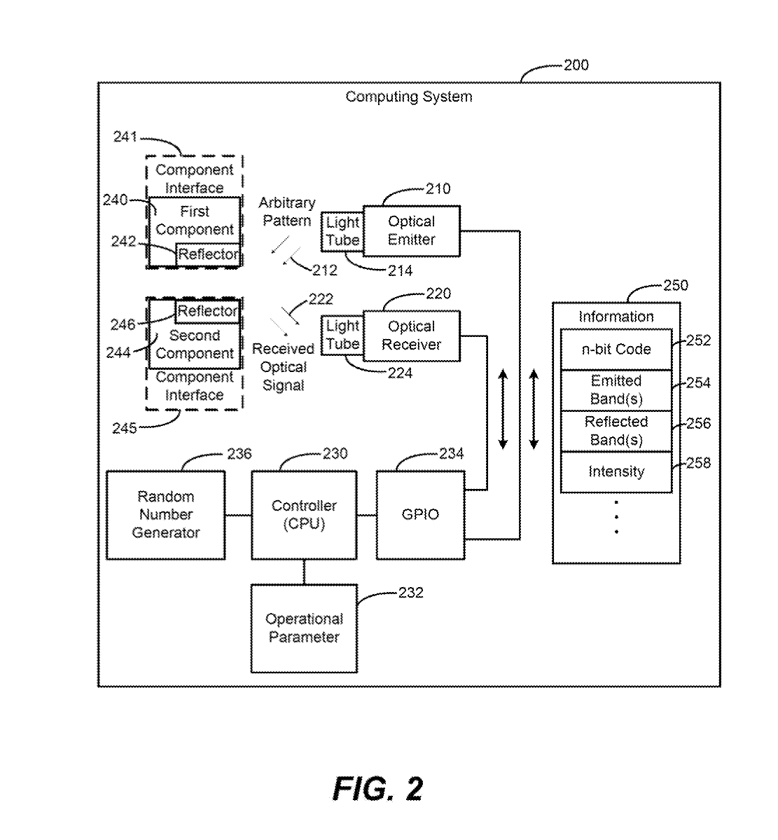

FIG. 2 is a block diagram of a computing system including an arbitrary pattern according to an example.

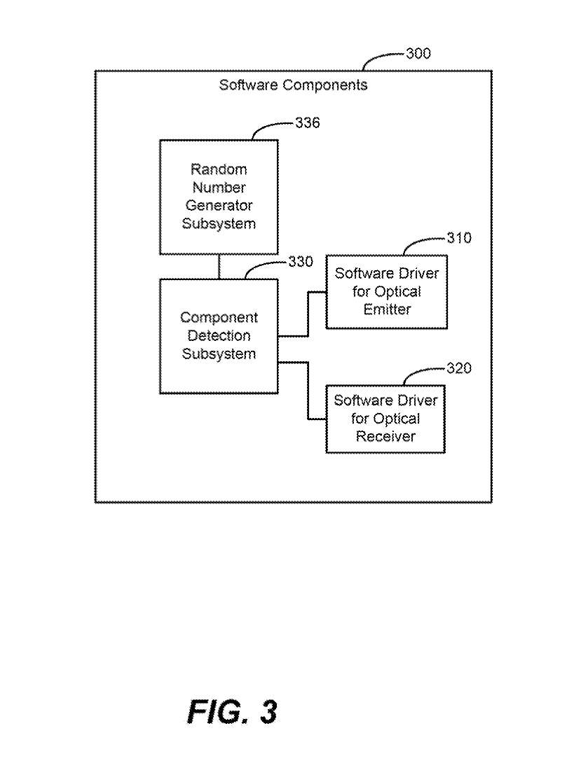

FIG. 3 is a block diagram of software components including a component detection subsystem according to an example.

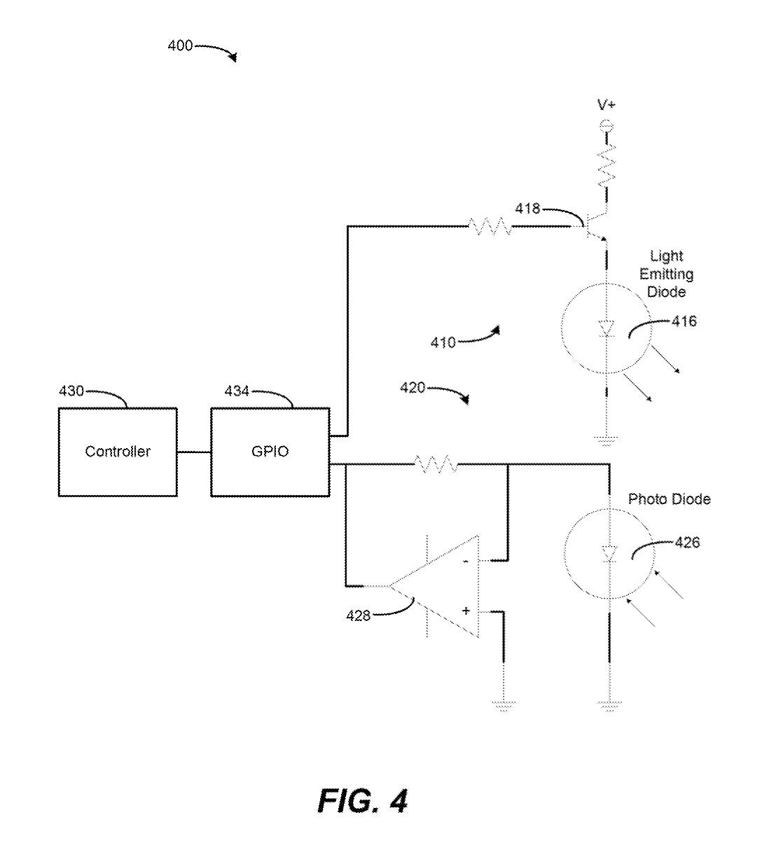

FIG. 4 is a system including emitter circuitry and receiver circuitry according to an example.

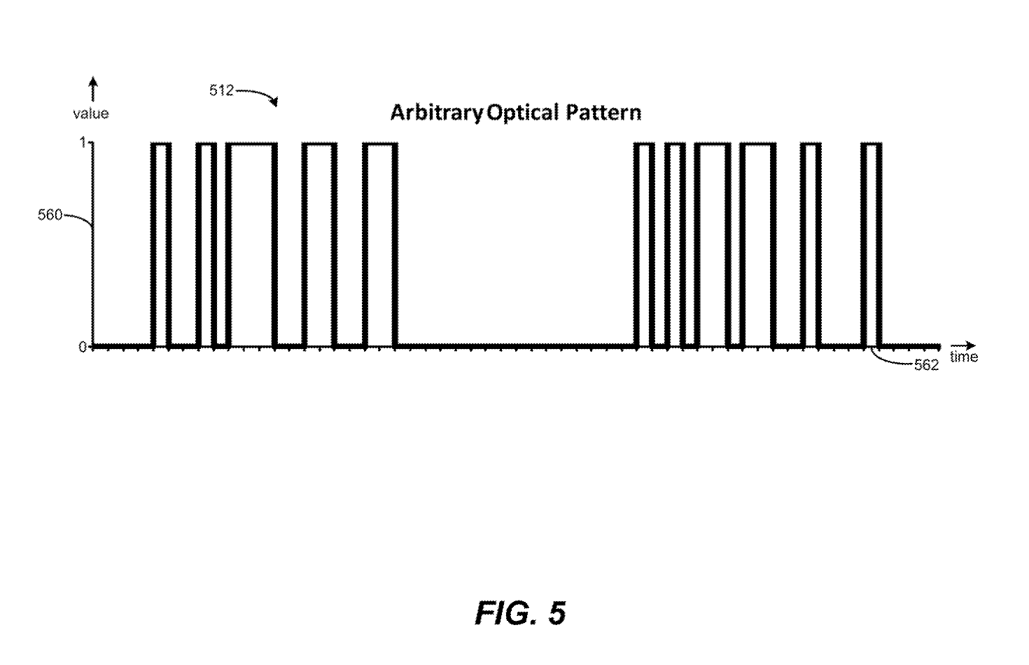

FIG. 5 is an arbitrary optical pattern according to an example.

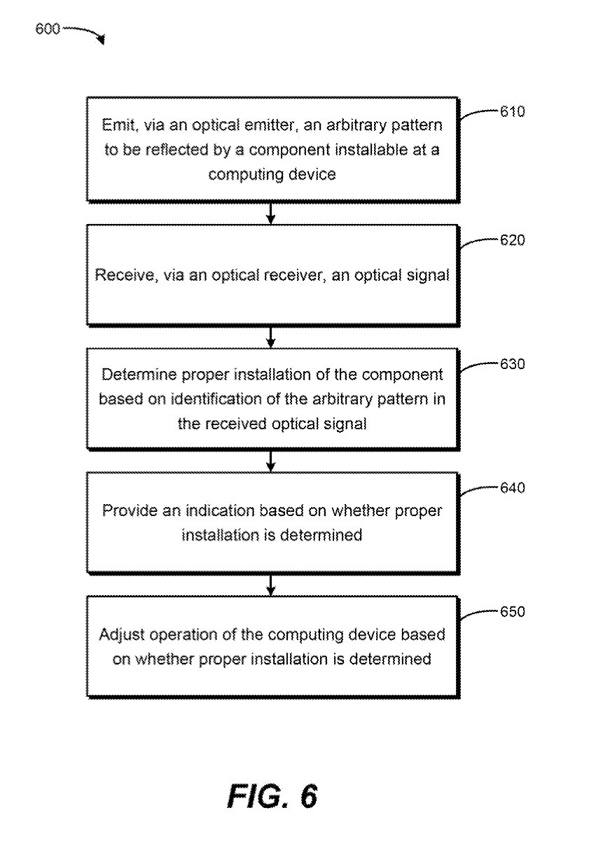

FIG. 6 is a flow chart based on adjusting a computing device according to an example.

### DETAILED DESCRIPTION

A computing device and/or computing system may be associated with a component that may be installed at the computing system. The computing system may operate differently based on what component(s) is/are installed, and a component may be capable of improper installation. For example, a fan component may be associated with airflow in a specific direction, but may be capable of being installed backwards or otherwise inconsistent with the specified airflow direction. A computing system may provide cooling based on heat-generating component(s) (e.g., a processor, a storage device, and the like) for a desired level of performance/operation of the heat generating component and the computing system. A computing system may provide proper cooling by adjusting operational parameters (e.g., increasing fan speed and/or ventilation) to compensate for increased heat generation, and/or to compensate for additional back-pressure of an installed air filter and/or opacity shield. Similarly, a computing system may adjust fan speed or other operational parameters to compensate for a disturbed airflow path (e.g., missing system panel or open computer case) to ensure proper operation without overheating.

In an example, an optical emitter may emit an arbitrary pattern to be reflected by a component installable at the computing device. An optical receiver may receive an optical signal. A controller may determine proper installation of the component based on identification of the arbitrary pattern in the received optical signal.

FIG. 1 is a block .diagram of a computing device 100 including an arbitrary pattern 112 according to an example. The computing device 100 may include an optical emitter 110 to produce the arbitrary pattern 112, an optical receiver 120 to receive a received optical signal 122, and a controller 130. The controller 130 may determine whether a component 140 is properly installed.

The computing device 100 may be a personal computer, a server, a network switch, and/or other devices/systems associated with the controller 130. Computing device 100 may be a stand-alone module (e.g., microcontroller) that may interface with a network switch or other device. The controller 130 may be a processor such as a Central Processing Unit (CPU), and may be a processing module including at least one processor. In an example, controller 130 may be a CPU of a network switch.

The computing device 100 may include a component interface to receive and/or align the component 140. Component 140 may include powered and/or passive components, including components that affect the computing device 100, such as affecting heat generation and/or heat dissipation of the computing device 100. Example components 140 may include a filter, an opacity shield (e.g., a louver and/or other component to affect light passage), a chassis/housing or other system panel, a fan, a processor, a storage device such as a hard disk or solid state drive (SSD), or other component. Component 140 may be optional, such that computing device 100 may be operated normally without installation of component 140, and may be operated with installation of component 140. Multiple components 140 may be used in combination, e.g., combining a filter component and an opacity shield component, such that individual and/or cumulative effects associated with each component may affect the computing device 100.

The computing device 100 may operate the optical emitter 110 to produce the arbitrary pattern 112. Use of the arbitrary pattern 112 may ensure that the received optical signal 122 corresponds to the produced signal from the optical emitter 110. Thus, use of the arbitrary pattern 112 may prevent false-positive signals, such as stray optical signals from fluorescent or LED-based ambient lighting systems, from being interpreted as the reflected arbitrary pattern 112. Additionally, the arbitrary pattern 112 may be unique to a computing device 100. For example, the arbitrary pattern 112 may be generated based on a random number having a high likelihood of uniqueness for each of the computing devices 100, such that a given model line of computing devices 100 do not share a common pulse train as the emitted optical signal and/or arbitrary pattern 112. Thus, detecting the unique arbitrary pattern 112 in the received optical signal 122 enables the computing device 100 to avoid false-positives such as receiving a stray arbitrary pattern from another computing device.

For example, a first computing device 100 may receive a stray optical signal from an adjacent computing device in close proximity to the first computing device 100. Example scenarios may include installation of multiple rows of racked computing devices 100 exposed to each other in a data center environment over years of usage, or on an assembly line to manufacture computing devices 100. However, the first computing device 100 may avoid falsely determining a proper installation when it receives the stray optical signal, because the stray optical signal would not include the particular arbitrary pattern 112 associated with the first computing device 100. A computing device 100 may distinguish one arbitrary pattern 112 from another, and determine whether a particular arbitrary pattern 112 is present to indicate proper installation (among other characteristics of the received optical signal 122 associated with proper installation, such as intensity and optical band(s) of received optical wavelengths).

The arbitrary pattern 112 may be produced based on the controller 130. The controller 130, such as a CPU, may include capabilities to generate random numbers. The arbitrary pattern 112 may be based on an n-bit code generated by a random number generator associated with the controller 130, such as a 32-bit code. A random number may enable the arbitrary pattern 112 to have a low probability of being non-unique across computing devices 100. Accordingly, computing device 100 may avoid a false-positive detection when in the presence of various arbitrary patterns 112 from other computing devices. Arbitrary patterns may be based on random number generators available in hardware and/or software. In an example, a software random number generator may be provided in a software stack of an operating system associated with the computing device 100 to provide random numbers to be used to produce the arbitrary pattern 112. A computing device 100 may produce a series of arbitrary patterns 112, e.g., produce a unique and/or new arbitrary pattern 112 for each scan for a component 140 by the optical emitter 110 and/or optical receiver 120.

Thus, the arbitrary pattern 112 may distinguish the received optical signal 122 from ambient light energy noise. The controller 130 also may use data error detection principles to isolate the arbitrary pattern 112 in the received optical signal 122, or otherwise accurately determine a type of the component 140 and whether component 140 is properly installed.

The optical emitter 110 may be based on emitters such as a light emitting diode (LED), laser, electroluminescent light source, incandescent light source, or other forms of lighting/optical signals of visible, infrared, and/or ultraviolet wavelengths, including wideband and/or narrowband sources. The optical receiver 120 may be based on a photovoltaic cell, charge-coupled device (CCD), phototransistor, photosensor, photodetector, or other component capable of detecting an optical signal. The optical emitter 110 and optical receiver 120 may be discrete components joined to controller 130 through standard interfaces. The optical emitter 110 and optical receiver 120 may be provided together as a module.

The computing device 100 may include multiple optical emitters 110, optical receivers 120, and/or emitter/receiver pairings, including combinations of different types of optical emitter(s) 110 and/or optical receiver(s) 120. A computing device 100 may use multiple optical receivers 120, to determine multiple characteristics such as a type, an orientation and/or position, and a proper/improper installation of at least one component(s) 140. The optical emitter 110 and/or optical receiver 120 may emit and/or receive signals over a portion of the electromagnetic spectrum based on at least one frequency and/or band of frequencies. Such optical characteristics may be varied, for example over time and/or based on a particular computing device and installation environment. In an example, a computing device. 100 may monitor for interference with other electronics or transceivers, and/or may choose a band of wavelengths to avoid interference.

The optical receiver 120 may be positioned within the computing device 100 to avoid stray received optical signals 122 not originating from the computing device 100. Thus, during operation in racks of a datacenter or manufacturing on an assembly line for example, the optical receiver 120 of a first computing device 100 may be prevented from detecting an optical signal from a second computing device on the assembly line, even when near the first computing device 100.

The component 140 may interact with the computing device 100 such that when the component 140 is properly installed, the arbitrary pattern 112 from the optical emitter 110 interacts with the component 140 to enable the optical receiver 120 to detect the arbitrary pattern 112 in the received optical signal 122. For example, the component 140 may partially or fully reflect the arbitrary pattern 112, and may provide a received optical signal 122 that is filtered or otherwise affected by the component 140.

The arbitrary pattern 112 may be reflected based on reflectivity characteristics associated with the component 140. The component 140 may include a surface with particular reflectivity to affect the received optical signal 122. In an example, a first surface of component 140 provides a high reflectivity compared to remaining surfaces of the component 140. The component 140 may reflect a particular band of wavelengths associated with the optical emitter 110, such that the received optical signal 122 includes a subset of wavelengths emitted by the optical emitter 110. Reflectivity of the component 140 may be affected by surface characteristics such as patterning, roughening, and other techniques, and may be affected by application of a material such as paint, resin, adhesive reflectors, or other techniques. Reflectivity, and a particular chosen surface and/or area, of the component 140 may be altered to correspond to detection of proper installation of the component 140.

Proper installation of the component 140 may relate to a position and orientation of the component 140, and may be based on physical dimensions of the component 140, physical dimensions of a component interface (if applicable), a position and/or orientation of a reflective portion of a surface of the component 140, and other factors. For example, emission of the arbitrary pattern 112 may extend across a portion of the component interface, and the component 140 may physically fit within the component interface in a specific position/orientation, such that a reflective portion of the component 140 cannot reflect the arbitrary pattern 112 unless the component 140 is properly installed. In an example, the component 140 is asymmetrically shaped corresponding to the component interface, and emission of the arbitrary pattern 112 does not extend beyond a chassis of the computing device 100. Accordingly, such factors and others may enable proper installation of the component 140 to be detected by the controller 130, based on identification of the arbitrary pattern 112 in the received optical signal 122.

The component 140 may provide an identification of the type of component based on different levels of reflectance, such as causing changes in received intensity and/or reflected band(s) of wavelengths. For example, a received optical signal 122 associated with a first reflected band may indicate an opacity filter, and a received optical signal 122 associated with a second reflected band may indicate a cooling fan. Additional associations between levels of reflectance and component types are possible, including various combinations of intensity and/or reflected band(s). The type of component 140, and its installation, may be identified by the controller 130.

Controller 130 may identify the component 140, determine whether the component 140 is installed properly, and/or adjust operational parameters of the computing device 100. For example, controller 130 may adjust operation of a fan in response to determining proper installation of a filter component 140. The controller 130 may determine proper installation of a fan component 140, and adjust operation of that fan component 140. The controller 130 may interact with other components of computing device 100 not specifically shown, including controlling a first component based on determining proper installation of a second component.

In an example, computing device 100 may be operated with or without component 140 (an air filter), depending on factors associated with the computing device 100 such as an installation environment. Controller 130 may determine that the air filter component 140 is not installed, and operate a cooling fan component (not shown in FIG. 1) according to a first set of operational parameters such as a lower RPM. Controller 130 may determine that the air filter component 140 is properly installed, and operate the cooling fan component according to a second set of operational parameters such as a higher fan RPM. Thus, the controller 130 may compensate for proper installation of the component 140 (e.g., an air filter, opacity shield, or other component), enabling proper operational performance of computing device 100 regardless of whether component 140 is installed or removed. The controller 130 may operate the computing device 100 at a first level of security based on a component (e.g., an opacity shield) not being installed properly, and may operate the computing device 100 at a second level of security based on the component being installed properly. In an example, the computing device 100 may limit access to guest privileges when the component is not installed, and may elevate access to administrator privileges when the component is installed.

FIG. 2 is a block diagram of a computing system 200 including an arbitrary pattern 212 according to an example. The computing system 200 may include a first component 240, a first component interface 241, a second component 244, and a second component interface 245. The first component 240 may be reflective and/or include at least one first reflector 242, and the second component 244 may be reflective and/or include at least one second reflector 246. The optical emitter 210 may be associated with at least one emitter light tube 214, and the optical receiver 220 may be associated with at least one receiver light tube 224.

Controller 230 (e.g., a CPU) may send and receive information 250 to/from the optical emitter 210 and optical receiver 220. The controller 230 may be associated with at least one operational parameter 232, a general purpose input/output (GPIO) 234, and a random number generator 236. The example of FIG. 2 shows one controller, optical emitter, one optical receiver, one arbitrary pattern, one received optical signal, and first and second components, component interfaces, light tubes, and reflectors. However, additional components, component interfaces, reflectors (and combinations of reflectors), light tubes, emitters, receivers, arbitrary patterns, received optical signals, and other features (controllers, GPIOs, etc.) may be included. Thus, a component may be identified based on a combination of reflectors/reflective areas on a given component (e.g., representing information based on a pattern of reflectors) detectable by the controller.

A reflector may be optional. A component may inherently provide a surface reflectivity for a received optical signal 222 to contain the arbitrary pattern 212. A reflector may be added to a component, e.g., added as an adhesive sticker or insert. The reflector may be integrated into the component, e.g., contained within molded plastic or otherwise incorporated into the component.

In an example, optical signals from the optical emitter 210 may travel through a light tube or light pipe (emitter light tube 214) to a component, and reflected light from the component may travel through a light tube or light pipe (receiver light tube 224) to the optical receiver 220. A light tube may branch off and provide multiple interfaces, such as with multiple components or with multiple reflectors etc.

The optical emitter 210 may emit a broad spectrum of various wavelengths at various levels of intensity, and a component and/or reflector may filter or otherwise affect reflected light to produce a narrower band pass of wavelengths and/or intensities in the received optical signal 222. Thus, a type of component and/or proper installation of a component may be detected and/or determined based on characteristics of the received optical signal 222, independently of or in conjunction with whether the arbitrary pattern 212 is contained in the received optical signal. The optical emitter 210 and/or the optical receiver 220 may be coupled to a module for General Purpose Input/Output (GPIO).

The GPIO 234 may provide functionality and interconnections between the controller 230, the optical emitter 210, and/or the optical receiver 220. The GPIO 234 may be omitted, with functionality and/or pin-out connections provided by the controller 230. For example, the emitter/receiver may be connected to standard-purpose input/output (IO) pins of a CPU controller 230, such that the CPU may orchestrate signals to/from the emitter/receiver. Interconnection functionality may be provided based on other implementations, such as a dedicated controller or microchip that drives the optical emitter 210 and/or the optical receiver 220 as components over a bus. Interconnections between various components/controllers may be based on standards such as an Inter-Integrated Circuit (I²C) bus, a “two-wire interface” bus, a low pin count (LPC) bus, or other interconnection systems. The GPIO 234 may be provided as a general purpose microcontroller with GPIO pins to communicate with the controller 230. GPIO functionality may be provided based on a block of pins provided for general use, programmable for input and/or output based on hardware registers and/or software to drive signal levels for interconnections with the emitter/receiver. A dedicated GPIO 234 may provide a specific interface for emitters/receivers that do not include an interface, such as a basic LED. In contrast, a more complex module used for the optical emitter 210 and/or optical receiver 220 may be tied to dedicated pins of the controller 230. The GPIO 234 may be provided as a functional block within the controller/CPU 230, and output of the GPIO 234 is not limited to specific pins.

The random number generator (RNG) 236 may be provided as a pseudorandom number generator (PRNG), a deterministic random bit generator (DRBG), a hardware random number generator (e.g., a separate module or an integrated module of a CPU etc.), a software implementation, and the like.

The information 250 may include various parameters for operating the optical emitter 210 and optical receiver 220, including an n-bit code 252, emitted band(s) 254, reflected band(s) 256, intensity 258, and other information. The information 250 may be sent to and/or received from the optical emitter 210 and/or the optical receiver 220. In an example, the information 250 may include initialization information for initializing the optical emitter 210 and/or optical receiver 220 for a particular configuration of a computing system 200. The optical emitter 210 and optical receiver 220 may be installable and customizable for various different computing systems 200, including systems having different chassis sizes, possible installable components/component interfaces, and possible positions and/or orientations of components. Accordingly, an example may include a module, such as an optical emitter/receiver module, installable in a variety of different computing systems, that may be electronically programmed/updated based on the particular installation application. An example may also include a module installable in a system, wherein the module may be trained/taught how to recognize a properly installed component. In an example, a component may be properly installed and the module may receive instructions to associate corresponding emitter/receiver information with proper installation, wherein the information may be shared with other modules, by downloading, copying, and the like).

The controller 230 may adjust an operational parameter 232 of the computing system 200 based on identification of and/or determining proper installation of a component. In an example, the operational parameter 232 may be adjusted based on a lookup at the controller 230 to identify component(s) based on information 250 received from the optical receiver 220 (e.g., reflected band(s) 256 and/or intensity 258 indicating a type of component, including reflection information from a combination of reflectors associated with a component).

In an example, a computing system 200 may determine proper installation of a first component 240 and a second component 244. First component 240 may be a fan including first reflector 242 associated with voltage, current, duty cycle, rated airflow, and other operational parameters 232 associated with the fan and usable by controller 230 (e.g., to operate the fan). A second component 244 may be a filter including second reflector 246 associated with data indicating effects the filter may have on airflow, including offsets for increasing voltage, current, duty cycle, or other operational parameters of the fan, to enable acceptable operation of the computing system 200, e.g., to offset back-pressure introduced by proper installation of the filter. Thus, the example computing system 200 may identify a type of component, may identify a proper installation of a component, may identify information regarding how to operate a properly installed component, and may identify how to adjust operation of the computing system (including operation of a properly installed first component) when a (first, second, and/or additional) component(s) is properly installed.

In an example, the first component 240 may be an air filter having a first capacity of air filtration and/or opacity (e.g., ability to block light passage). The second component 244 may be an air filter having a greater capacity of air filtration and/or opacity. Components may include system panels or other features that may affect the computing system 200, such as by affecting airflow and/or operation of other components. Accordingly, controller 230 may compensate for cumulative effects of various components, including whether the components are properly installed.

Controller 230 may determine proper installation of a component. Controller 230 may provide information 240, operational parameter(s) 232, and other determinations regarding a component and/or the computing system 200. For example, controller 230 may determine that a component is properly installed and provide operational parameter 232 (e.g., an indication such as lights, text, sounds, or other feedback that may communicate installation status information). In another example, controller 230 may determine whether a component is original equipment manufacture (OEM), aftermarket/replacement, genuine or counterfeit, based on reflected band(s) 256 or other information 250, for example.

The controller 230 may make additional determinations such as a determined operational fault to indicate that detected component(s) do not correspond to an acceptable scenario/configuration of the computing system 200. For example, the controller 230 may determine that a first component 240 and a second component 244 are individually installed properly. However, the controller 230 may determine that the first component 240 and the second component 244 are incompatible with each other and should not be installed simultaneously on the computing system. For example, the first component 240 may be a fan to provide airflow sufficient for the computing system 200, but the second component 244 may be a highly restrictive filter that causes the overall airflow to be insufficient for cooling the computing system 200 with that fan. Thus, the controller 230 may trigger a fault condition.

Information 250 and operational parameter(s) 232 may be associated with information corresponding to various aspects of the computing system 200, including first component 240, second component 244, and other aspects of computing system 200. Controller 230 may, therefore, provide information 250, operational parameter(s) 232, and/or adjustments specifically suited to a particular component or other aspect of computing system 200. Similarly, controller 230 may be associated with information for a particular computing system 200, e.g., based on attributes such as a flow-pressure curve associated with airflow through a specific computing system 200 and its various configurations (e.g., when a particular combination of system panel components are installed). Such information may be preprogrammed, updated, learned, and/or trained by operation of computing system 200, and otherwise associated with controller 230.

Controller 230 may provide determinations based on an identified received optical signal 222 and information available to the controller 230 (e.g., a lookup table of information for the controller 230 to cross-reference the received optical signal 222 to obtain corresponding information relevant to the identified component). In an example, the controller 230 may receive a received optical signal 222 having a reflected band 256 and/or intensity 258 associated with a particular reflectance. The controller 230 may then lookup the reflected band 256 and determine a correspondence to a fan having specific flow-pressure curve(s) and specific flow-current curve(s), e.g., curves associated with various duty cycles and/or voltages. The controller 230 may look up a list of acceptable identifications for reflected band(s) 256 and/or intensity 258, and determine whether a component is acceptable based on whether the identifications are among the list. The controller 230 may determine proper installation of a component based on one optical emitter 210, without needing to use multiple optical emitters/receivers or at least one reflector(s), to determine position, orientation, and/or other factors associated with proper installation.

FIG. 3 is a block diagram of software components 300 including a component detection subsystem 330 according to an example. The component detection subsystem 330 may be associated with a software driver for the optical emitter 310, a software driver for the optical receiver 320, and a random number generator subsystem 336.

Software components 300 may be provided as higher-level implementations, such as components compatible with an operating system (OS) or other higher level software executable on a computing device. The components may interpret signals to/from a GPIO, for example, and may run as part of the OS to monitor the GPIO or other communications with the emitter/receiver. Software components may be customized to run on a particular computing device.

The software components 300 may be compatible with a real-time operating system, and may be implemented as device drivers included in the OS that are capable of working with the emitter/receiver. The device drivers may direct the signals to be driving the IO pins of the physical devices (emitter/receiver). A low-level driver may drive the physical signals, and another higher-level software layer on top may monitor driving durations of the component signals and interface with components. Thus, the random number generator subsystem 336 may interface with a random number generating module to provide an n-bit random number. The software driver for the optical emitter 310 may interface with the optical emitter to use the n-bit random number to generate an arbitrary pattern to be emitted. The software driver for the optical receiver 320 may similarly drive an optical receiver. Physical inputs for intercommunications may be received through GPIO pins/modules, and the software components 300 may pass pulses, including converting the pulses, to higher level components and map out responses to modules driving the optical emitter. The component detection subsystem 330 may coordinate between the software components 300, and may identify and operate various accessories/components and determine whether they are present and operable. Functionality also may be provided as low-level CPU specific responses.

FIG. 4 is a system 400 including emitter circuitry 410 and receiver circuitry 420 according to an example. System 400 also may include controller 430 and GPIO 434. System 400 may include circuitry to account for emitter/sensor voltage being too high or too low for the GPIO 434, adjusting the raw values accordingly for compatibility with the GPIO 434 by modifying the GPIO pin signals (e.g., before entering the GPIO from the receiver and/or before sending output to the emitter). Signals from the GPIO 434 may be coupled to the controller 430.

In an example, the emitter circuitry 410 may include a transistor 418, coupled to the GPIO 434 via a resistor. The transistor 418 may be coupled to a voltage supply V+ via a resistor, and may be coupled to a light emitting diode 416 that is coupled to ground. The receiver circuitry 420 may include an operational amplifier 428 and a resistor to couple a photo diode 426 to the GPIO 434 and ground. Thus, the emitter circuitry 410 and receiver circuitry 420 enable the controller 430 to drive light emitting diode 416 and photo diode 426 via GPIO 434. Other arrangements of electrical elements, such as transistors, resistors, capacitors, and the like, may be used to provide circuitry for driving emitters and/or receivers and interface with the controller 430 and/or the GPIO 434.

FIG. 5 is an arbitrary optical pattern 512 according to an example. The arbitrary optical pattern 512 is shown as a series of 57 bits having random values 560 of 1 and 0 over time 562, representing the binary expression:
000001001011100110011000000000000000010101101100100010000

The arbitrary optical pattern 512 may be produced based on a randomly generated string of bits. Thus, a controller may generate the arbitrary optical pattern 512, cause the arbitrary optical pattern 512 to be emitted and reflected, and determine if the arbitrary optical pattern 512 is contained within a received optical signal. Because the arbitrary optical pattern 512 is very likely to be unique among a large number of devices, detection of the specifically generated arbitrary optical pattern 512 is very unlikely to be caused by noise or stray signals from other devices. Thus, a system may use the arbitrary optical pattern 512 to determine whether a component is installed with a very high degree of confidence that false-positives are excluded. The degree of uniqueness and degree of confidence may be extended by using arbitrarily large number of randomly generated bits. For example, in a data center environment, multiple computing devices may be exposed to each other over a number of years. Thus, the arbitrary optical pattern 512 may be chosen to avoid a false-positive among multiple devices exposed to each other over an arbitrarily large number of emission/detection cycles over time.

FIG. 6 is a flow chart 600 based on adjusting a computing device according to an example. In block 610, an optical emitter is to emit an arbitrary pattern to be reflected by a component installable at a computing device. For example, an LED device may be flashed based on a specific arbitrary pattern generated randomly but known to the device. In another example, the component may be installable at the computing device based on a component interface that is to physically interact with the component and provide an orientation and position for the component to assume when installed. For example, the component interface may be asymmetric to enable the component to be installed one way, preventing reception of a desired optical signal (e.g., a desired intensity, reflected band(s), arbitrary pattern, and/or other desirable characteristics) unless the component has a proper orientation and position associated with proper installation. The component may include a surface having a reflectivity different from other surfaces, such that the surface faces the emitter/receiver when the component is properly installed.

In block 620, an optical receiver is to receive an optical signal. In an example, the receiver is capable of identifying whether the arbitrary pattern is contained, and may be capable of receiving/identifying other characteristics of the received optical signal including optical bands/wavelengths and intensities.

In block 630, proper installation of the component is determined based on identification of the arbitrary pattern in the received optical signal. For example, the component may reflect the arbitrary pattern when associated with a specific position and/or orientation, by presenting a specific surface reflectance to the emitted arbitrary pattern that is reflected to an optical receiver.

In block 640, the system may provide an indication based on whether proper installation is determined. For example, a controller may provide status information such as an LED, text indication, or signal to indicate and/or communicate whether proper installation is determined.

In block 650, operation of the computing device is adjusted based on whether proper installation is determined. For example, a controller may adjust an operational parameter of a fan or processor of the computing system when the controller determines that a filter is properly installed (e.g., installed properly such that the filter affects back-pressure of airflow through and/or cooling of the computing system). In an example, a type of component is determined based on characteristics of the received optical signal. For example, the controller may use a lookup table to cross-reference a type of component to obtain information associated with the component, such as a low-flow, medium-flow, or high-flow air filter, or other information such as adjustment of an operational parameter for the computing system. In an example, the controller may determine that the component is a low-flow filter type, and increase fan RPM to a high-speed to compensate for the low-flow filter in order to operate the computing system and maintain a desired level of cooling. The computing system may adjust other aspects, such as throttling a processor, adjusting security privileges, and adjusting operation of components such as storage, networking, wireless, and other devices based on determining proper installation of a component.

At least one block in flow chart 600 may be omitted. For example, block 640 may be omitted, such that a computing system operates without providing indications whether proper installation is determined. Block 650 may be omitted, such that operation of the computing device continues unchanged independently of whether proper installation is determined (e.g., the computing device may provide a notification without interrupting or changing operation).

What is claimed is:

1. A computing device comprising:
an optical emitter to emit an arbitrary pattern to be reflected by a component installable at the computing device;
an optical receiver to receive an optical signal; and
a controller to determine proper installation of the component based on identification of the arbitrary pattern in the received optical signal.

2. The computing device of claim 1, wherein the controller is to determine the proper installation based on a position and an orientation of the component associated with installation at a component interface of the computing device such that the receiver receives the optical signal containing the arbitrary pattern.

3. The computing device of claim 1, wherein the controller is to adjust an operational parameter associated with the computing device in response to the proper installation being determined.

4. The computing device of claim 1, wherein the controller is further to determine proper installation of the component based on an intensity of the received optical signal.

5. The computing device of claim 1, wherein the arbitrary pattern is represented by an n-bit code based on a random number generator.

6. The computing device of claim 5, wherein the controller is to generate a new n-bit code for an emission of the arbitrary pattern.

7. The computing device of claim 1, further comprising a light tube associated with at least one of the emitter and the receiver.

8. The computing device of claim 1, wherein the controller is a Central Processing Unit (CPU) including at least one General Purpose Input/Output (GPIO) pin to interact with at least one of the emitter and receiver.

9. A computing system comprising:
an optical emitter to emit an arbitrary pattern;
a component installable at the computing device to reflect the arbitrary pattern;
an optical receiver to receive an optical signal; and
a controller to determine proper installation of the component based on identification of the arbitrary pattern in the received optical signal.

10. The computing system of claim 9, further comprising a component interface to align the component to reflect the arbitrary pattern such that it is received by the receiver to indicate proper installation of the component, and to prevent the component from reflecting the arbitrary pattern to the receiver if the component is not properly installed.

11. The computing system of claim 9, further comprising a reflector associated with the component to reflect the arbitrary pattern.

12. The computing system of claim 11, wherein the reflector is to reflect an optical band portion of the arbitrary pattern to identify a type of the component.

13. The computing system of claim 12, wherein the controller is to adjust an operational parameter associated with operating the computing system based on the identified type of the component.

14. A method, comprising:
emitting, via an optical emitter, an arbitrary pattern to be reflected by a component installable at a computing device;
receiving, via an optical receiver, an optical signal; and
determining proper installation of the component based on identification of the arbitrary pattern in the received optical signal.

15. The method of claim 14, further comprising adjusting operation of the computing device based on whether proper installation is determined.
